(19) United States
(12) Patent Application Publication
(10) Pub. No.: US 2021/0060836 A1
(43) Pub. Date: Mar. 4, 2021

(54) METHOD FOR MANUFACTURING HOLLOW RESIN MOLDED ARTICLE AND DEVICE FOR MANUFACTURING HOLLOW RESIN MOLDED ARTICLE

(71) Applicant: TOYODA GOSEI CO., LTD., Kiyosu-shi, Aichi-ken (JP)

(72) Inventors: Yusuke NODA, Kiyosu-shi, Aichi-ken (JP); Akio YAMAGUCHI, Kiyosu-shi, Aichi-ken (JP); Shigekazu AKAHOSHI, Kiyosu-shi, Aichi-ken (JP); Yoshiaki SUGATA, Kiyosu-shi, Aichi-ken (JP)

(21) Appl. No.: 16/957,937

(22) PCT Filed: Mar. 30, 2018
(86) PCT No.: PCT/JP2018/013770

§ 371 Date: Jun. 25, 2020

(51) Int. Cl. B29C 45/17

(52) U.S. Cl. CPC B29C 45/1704; B29C 45/1734

(57) ABSTRACT

To further improve hollow resin molded article manufacturing technology, a hollow resin molded article manufacturing method includes: injecting a melted resin material into a cavity of a mold; injecting gas and liquid into the cavity in which the resin material has been injected, via an injector connected to the cavity, to form a hollow portion in the resin material in the cavity; and discharging the liquid in the cavity to outside of the cavity. The hollow portion forming step includes injecting the gas in a compressed state into the injector and then injecting the liquid pressurized at higher pressure than the gas. The injector is connected to a vertically lowermost end of the cavity. In the discharging step, the liquid is discharged via the injector.

### TECHNICAL FIELD

The present invention relates to a method for manufacturing a hollow resin molded article and a device for manufacturing a hollow resin molded article.

### BACKGROUND ART

As technology for manufacturing a hollow resin molded article, molding methods called gas assisted molding and water assisted molding are known (see, for example, Patent Literature 1 and 2). In this type of molding method, a fluid cooling medium such as gas or water is injected into a cavity of a mold in which a resin material in a melted state has been injected, to form a hollow portion by the cooling medium inside the resin material in a melted state. The resin material in a melted state is cooled by a mold surface of the mold and the cooling medium present at the hollow portion, so as to be solidified, and thus becomes a hollow resin molded article having a surface shape based on the mold surface of the mold and a hollow shape based on the hollow portion.

In this type of molding method, a fluid such as gas or water needs to be pressed into the cavity of the mold. For example, Patent Literature 1 uses a method in which the fluid is stored in a pressurized state in a pressure accumulating container such as an accumulator and the high-pressure fluid is pressed into the mold.

In the method shown in Patent Literature 1, an expansion force of the high-pressure fluid continues acting on the pressure accumulating container and peripheral circuit components such as valves and pipes connected to the pressure accumulating container. Therefore, there is a problem that the compression container and the peripheral circuit components are likely to be deteriorated. Deterioration of the compression container and the peripheral circuit components leads to difficulty in pressing the fluid into the mold at a desired pressure and a desired timing.

In this regard, in the technology shown in Patent Literature 2, nitrogen gas and water are used as the fluid, and the water is pressurized by a piston, thus eliminating the need of the pressure accumulating container. However, in the technology of Patent Literature 2, the nitrogen gas and the water are pressurized at the same time by the same piston. The nitrogen gas which is gas and the water which is liquid are greatly different in the compression amounts, i.e., the volume change amounts when the nitrogen gas and the water are pressurized at a constant temperature and a predetermined pressure. Therefore, even the technology shown in Patent Literature 2 has difficulty in pressing the nitrogen gas and the water into the mold at desired pressures and desired timings.

In the above manufacturing methods, a fluid remains inside a hollow resin molded article present in the cavity after molding. In order to manufacture a hollow resin molded article having an excellent quality, a process of discharging the fluid to the outside of the cavity is needed. Patent Literature 1 shows technology of introducing gas into the cavity by a gas injector provided separately. With this technology, some of the liquid remaining in the cavity is considered to be discharged to the outside of the cavity. However, in order to completely remove the liquid in the cavity by this technology, a large amount of gas needs to be introduced into the cavity by the gas injector, leading to complication of the mold structure and the accompanying equipment, and therefore such a method is not practical.

Accordingly, further improvement of technology for manufacturing a hollow resin molded article is desired.

### CITATION LIST

### Patent Literature

Patent Literature 1: U.S. Pat. No. 7,914,727(B2)

Patent Literature 2: JPH06-285897(A)

### SUMMARY OF INVENTION

### Technical Problem

The present invention has been made in view of the above circumstances, and an object of the present invention is to further improve technology for manufacturing a hollow resin molded article.

### Solution to Problem

In order to achieve the above object, a method for manufacturing a hollow resin molded article according to the present invention includes: a resin injection step of injecting a resin material in a melted state into a cavity of a mold; a hollow portion forming step of injecting gas and liquid into the cavity in which the resin material has been injected, via an injector connected to the cavity, to form a hollow portion in the resin material in the cavity; and a discharging step of discharging the liquid in the cavity to outside of the cavity, wherein the hollow portion forming step includes a pressurizing step of injecting the gas in a compressed state into the injector and then injecting the liquid pressurized at higher pressure than the gas, the injector is connected to a vertically lowermost end of the cavity, and in the discharging step, the liquid is discharged via the injector.

In order to achieve the above object, a device for manufacturing a hollow resin molded article according to the present invention includes: a mold having a cavity; a molding machine configured to inject a resin material in a melted state into the cavity; and a water assist unit configured to inject gas and liquid into the cavity in which the resin material has been injected, via an injector connected to the cavity, to form a hollow portion in the resin material in the cavity, wherein the water assist unit includes a gas injection mechanism configured to supply the gas in a compressed state to the injector, and a liquid injection mechanism configured to supply the liquid in a pressurized state to the injector, and the injector is connected to a vertically lowermost end of the cavity.

### Advantageous Effects of Invention

The method and device for manufacturing a hollow resin molded article according to the present invention contribute to improvement of technology for manufacturing a hollow resin molded article.

### BRIEF DESCRIPTION OF DRAWINGS

FIG. 1 schematically illustrates a device for manufacturing a hollow resin molded article according to an embodiment;

FIG. 2 schematically illustrates manufacturing of the hollow resin molded article according to the embodiment;

FIG. 3 schematically illustrates manufacturing of the hollow resin molded article according to the embodiment;

FIG. 4 schematically illustrates manufacturing of the hollow resin molded article according to the embodiment;

FIG. 5 schematically illustrates manufacturing of the hollow resin molded article according to the embodiment;

FIG. 6 schematically illustrates manufacturing of the hollow resin molded article according to the embodiment;

FIG. 7 schematically illustrates manufacturing of the hollow resin molded article according to the embodiment;

FIG. 8 schematically illustrates manufacturing of the hollow resin molded article according to the embodiment; and

FIG. 9 schematically illustrates manufacturing of the hollow resin molded article according to the embodiment.

### DESCRIPTION OF EMBODIMENTS

Hereinafter, as necessary, a method for manufacturing a hollow resin molded article according to the present invention may be simply referred to as a manufacturing method according to the present invention. In addition, as necessary, a device for manufacturing a hollow resin molded article according to the present invention may be simply referred to as a manufacturing device according to the present invention. Further, as necessary, the manufacturing method according to the present invention and the manufacturing device according to the present invention may be collectively referred to simply as present invention.

The manufacturing method according to the present invention includes a resin injection step, a hollow portion forming step, and a discharging step.

Among these, the resin injection step is a step of injecting a resin material in a melted state into a cavity of a mold. The resin material in a melted state means that the resin material is in a state exhibiting fluidity. In the present invention, the kind of the resin material is not particularly limited, and is, for example, a thermoplastic resin such as polyamide. Hereinafter, the resin material in a melted state is referred to as melted resin material, as necessary.

In the resin injection step, the melted resin material is injected into a cavity defined by the mold surface of the mold. At this time, the surface of the melted resin material inside the cavity is cooled by the mold surface, but the center part thereof is maintained in a melted state.

In the hollow portion forming step, gas is injected into the cavity in which the melted resin material has been injected, and then liquid is injected thereto. In the hollow portion forming step, a hollow portion filled with the gas and the liquid is formed substantially at a center part of the melted resin material in the cavity. The temperature of the liquid is lower than the temperature of the melted resin material. Therefore, the melted resin material in the cavity is cooled by the mold surface of the mold and the liquid in the hollow portion, so as to be solidified, and thus becomes a hollow resin molded article having a hollow shape. The reason why the gas is injected into the mold before injection of the liquid is to suppress rapid cooling of the melted resin material. That is, if the melted resin material first comes into contact with the liquid, the melted resin material is rapidly cooled and solidified. This causes great difficulty in forming a hollow portion having a desired shape in the melted resin material, and therefore manufacturing of a hollow resin molded article having a desired shape and a desired quality becomes difficult. Bringing the gas into contact with the melted resin material before the liquid suppresses rapid cooling of the melted resin material, and by the gas and the liquid, a sufficient pressure is applied from the inner side of the melted resin material toward the mold surface of the mold, thereby enabling manufacturing of a hollow resin molded article having a desired shape and a desired quality. In the hollow portion forming step, the gas is present at the leading end part in the direction in which the hollow portion is formed. The gas present at the leading end part of the hollow portion has an advantage of assisting the discharging step described later.

In consideration of such a function of the gas, the amount of the gas to be injected into the mold is set to be greater than the volume of the hollow portion at the atmospheric pressure, and is preferably about 1.2 to 3.0 times the volume of the hollow portion.

Since the gas is to be injected into the cavity in which the melted resin material has been injected, the gas needs to be injected in a compressed state into the cavity. Here, the compressed state refers to a state of being pressurized at higher pressure than the atmospheric pressure. Preferably, the gas is pressurized to such a degree as to push against the back flow of the melted resin material from the cavity, and more preferably, the pressure of the gas is in a range of 0.5 to 1.0 MPa.

Meanwhile, the liquid is injected into the cavity in a state of being pressurized at higher pressure than the gas. Here, the higher pressure refers to a pressure higher than the pressure of the gas. Although the pressure of the liquid is not particularly limited, the liquid is pressurized to such a degree as to be injected while pushing away the melted resin material, and preferably, the pressure of the liquid is in a range of 6.0 to 12.0 MPa.

Preferably, gas that is low in reactivity with the melted resin material is selected as the gas to be injected in the hollow portion forming step. Examples of such gas that is low in reactivity with the melted resin material include air or inert gas such as nitrogen. Air includes a large amount of nitrogen as inert gas, and the cost thereof is low. Therefore, air is preferably used. The temperature of the gas is not particularly limited.

As the liquid to be injected in the hollow portion forming step, liquid that is low in reactivity with the resin material is selected. As the liquid, water is preferably used in terms of cost.

The liquid injected into the cavity in the hollow portion forming step has lower temperature than the melting point of the melted resin material. Preferably, the temperature of the liquid is 40 to 50° C. For reference, the melting point of Nylon 66 which is a kind of polyamide is about 270° C.

In the manufacturing method according to the present invention, the gas and the liquid are injected into the cavity via the injector connected to the cavity. In addition, the hollow portion forming step includes a pressurizing step of injecting the gas in a compressed state into the injector and then injecting the liquid pressurized at higher pressure than the gas into the injector.

In other words, in the manufacturing method according to the present invention, although the gas and the liquid are each injected into the cavity via the injector, the gas and the liquid are each already in a pressurized state at the time of being injected into the injector. As described above, in the manufacturing method according to the present invention, each of the gas and the liquid is individually pressurized at a stage before reaching the injector. Therefore, each of the pressure of the gas and the pressure of the liquid is easily set individually, as compared to the case of pressurizing gas and liquid by a piston at the same time. Thus, the manufacturing method according to the present invention has an advantage of enabling the gas and the liquid to be injected into the cavity of the mold at desired pressures and desired timings.

The manufacturing method according to the present invention includes the discharging step in addition to the resin injection step and the hollow portion forming step.

The discharging step is a step of discharging the liquid present in the cavity after the hollow portion forming step. In the discharging step, the liquid is discharged via the injector.

The injector is connected to the vertically lowermost end of the cavity. Therefore, when injection of the gas and the liquid into the cavity is stopped, the liquid remaining in the cavity, specifically, the liquid remaining in the hollow portion of the hollow resin molded article is discharged by self-weight from the hollow portion toward the injector. Thus, the manufacturing method according to the present invention enables the liquid in the cavity to be easily discharged.

In the manufacturing method according to the present invention, the gas and the liquid are each pressurized at the time of being injected into the cavity, instead of continuing holding the pressure of the liquid by a pressure accumulating container such as an accumulator. That is, the manufacturing method according to the present invention does not need the pressure accumulating container. Therefore, the problem that the pressure accumulating container and the peripheral circuit components are deteriorated is avoided, and disadvantage due to such deterioration, i.e., reduction in molding accuracy of the hollow resin molded article is also suppressed.

In the manufacturing method according to the present invention, in the hollow portion forming step, the states of the gas and/or liquid to be injected into the mold may be detected, and whether the hollow resin molded article is a proper product or a defective product may be determined in accordance with the obtained detection result.

Here, the “states” of the gas and/or the liquid refer to the pressures, the flow speeds, the flow rates, the temperatures, or the like of the gas and/or the liquid, for example. In the hollow portion forming step, such a “state” as described above is detected, thereby determining whether or not each of the gas and the liquid is to be injected into the melted resin material in the cavity by a necessary amount and at a necessary pressure. If a detection result is abnormal, the obtained product, i.e., the hollow resin molded article is determined to be a defective product.

Preferably, in the case where determination indicating abnormality is made a plurality of times, manufacturing of the hollow resin molded article is stopped at the time when the cycle for which the determination indicating abnormality is made is completed to the end, and the next cycle for manufacturing a hollow resin molded article is not performed.

Further, adjusting the above “states” as appropriate on the basis of the detection result enables each of the gas and the liquid to be actually injected into the melted resin material in the cavity by a necessary amount and at a necessary pressure, thereby enhancing the molding accuracy of the hollow resin molded article.

Even in the case where, for example, a part of the device for manufacturing a hollow resin molded article is deteriorated over time so that the temperature/pressure output of the manufacturing device is decreased and the above “states” deviate from anticipated values, detecting the “states” and adjusting the “states” on the basis of the detection results enables each of the gas and the liquid to be actually injected into the melted resin material in the cavity by a necessary amount and at a necessary pressure, thereby enhancing the molding accuracy of the hollow resin molded article. Thus, deterioration in molding accuracy of a hollow resin molded article is suppressed, and manufacturing of a defective product is prevented.

The manufacturing device according to the present invention includes a mold, a molding machine, and a water assist unit. Among these, the water assist unit includes an injector, a gas injection mechanism, and a liquid injection mechanism.

The injector is as described above. The gas injection mechanism and the liquid injection mechanism respectively supply the gas and the liquid in pressurized states to the injector. Specifically, the gas injection mechanism and the liquid injection mechanism each have a drive machine such as a motor or a solenoid, and pressurize the gas/liquid by the drive machine, to transport the gas/liquid to the injector.

The drive machine is not limited to a particular type, and a known drive machine such as a servomotor, a stepping motor, or a solenoid may be selected.

In particular, the liquid injection mechanism preferably includes a hydraulic pump mechanism having such a drive machine as described above. Since the liquid injection mechanism is for pressurizing liquid, the liquid injection mechanism itself is also subjected to a comparatively great pressure. The hydraulic pump mechanism uses hydraulic oil as a hydraulic medium, and the hydraulic oil flows through the hydraulic pump mechanism itself. Therefore, most parts of the hydraulic pump mechanism are oiled with the hydraulic oil. Thus, the hydraulic pump mechanism undergoes less deterioration in durability than a pressure accumulating container such as an accumulator which directly stores liquid such as water. If a part of the device for manufacturing a hollow resin molded article is formed by a hydraulic pump mechanism instead of an accumulator, the durability of the device for manufacturing a hollow resin molded article itself is also improved. Thus, using a hydraulic pump mechanism as the liquid injection mechanism imparts high durability to the manufacturing device according to the present invention, and improves the molding accuracy of a hollow resin molded article manufactured by the manufacturing device according to the present invention.

In particular, the hydraulic pump mechanism is preferably a hydraulic servo pump mechanism subjected to control in a servo control system. The servo control system refers to a control system for causing the position, the orientation, the attitude, or the like of an object to follow a target value. In the liquid injection mechanism of the manufacturing device according to the present invention, components of the liquid injection mechanism such as the drive machine may be subjected to feedback control so that the amount of pressurization for the liquid becomes a target value. As used herein, the target value not only refers to a numerical value but also includes a range.

Using a hydraulic servo pump mechanism as the liquid injection mechanism enables accurate control for the timing of pressurizing the liquid and the pressurizing force therefor, thereby further enhancing the molding accuracy of the hollow resin molded article.

In the manufacturing device according to the present invention, the gas injection mechanism for supplying the gas in a compressed state to the injector and a liquid injection mechanism for supplying the liquid in a pressurized state to the injector are provided separately from each other, thus obtaining an advantage of facilitating individual setting for the pressure of the gas and the pressure of the liquid, as described above in the manufacturing method according to the present invention.

Also in the manufacturing device according to the present invention, the injector is connected to the vertically lowermost end of the cavity. Therefore, in the manufacturing device according to the present invention, as described above in the manufacturing method according to the present invention, the liquid remaining in the hollow portion in the hollow resin molded article is discharged by self-weight toward the injector after the hollow portion forming step. Thus, the liquid in the cavity is easily discharged.

Preferably, the manufacturing device according to the present invention further includes a detection element for detecting the states of the gas and/or liquid to be injected into the mold. The detection element may be provided at one location on a path through which the gas flows, a path through which the liquid flows, a path composing the liquid injection mechanism, or a path composing the gas injection mechanism in the manufacturing device according to the present invention, and preferably, such detection elements are provided at a plurality of locations. As the detection element, various sensors such as a pressure sensor, a flow rate sensor, and a temperature sensor may be selected as appropriate.

Preferably, the manufacturing device according to the present invention includes a control element for controlling the manufacturing process and/or the manufacturing device on the basis of a detection result from the above detection element. As the control element, for example, a known device such as a computer including a computation element and a storage element may be used.

The control element may perform determination for a proper product and a defective product and/or stoppage of manufacturing as described above, or may perform another control.

For example, the control element may warn an operator that abnormality has occurred. As specific examples of the warning, the fact that the abnormality has occurred or a part where the abnormality has occurred may be displayed on a monitor, a warning light may be lit up, or a warning buzzer may be sounded.

The control element may adjust the “state” through feedback of a detection result from the above detection element. In this case, the control element may be connected to the liquid injection mechanism, the gas injection mechanism, and the molding machine, in addition to the detection element.

Hereinafter, the manufacturing method and the manufacturing device according to the present invention will be described with reference to specific examples.

Unless otherwise specified, a numerical value range “x to y” described herein includes, in the range thereof, a lower limit x and an upper limit y. A numerical value range is formed by arbitrarily combining such upper limit values and lower limit values as well as numerical values described in the embodiment. A numerical value range is formed by arbitrarily combining these values. A numerical value optionally selected from the numerical range may be used as the numerical value of the upper or lower limit.

### Embodiment

A method for manufacturing a hollow resin molded article according to the embodiment is a method for manufacturing a hollow resin molded article using polyamide as a resin material, using air as gas, and using water as liquid.

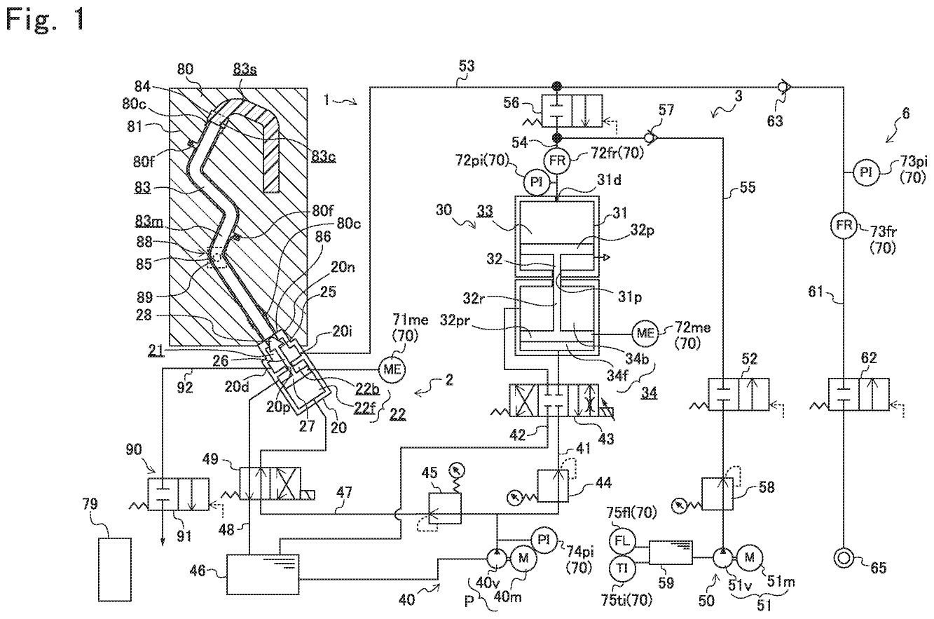

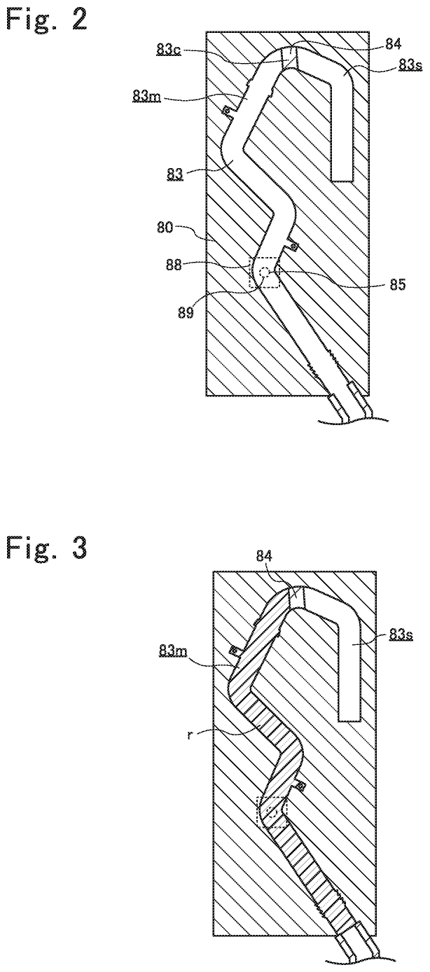

FIG. 1 schematically illustrates a device for manufacturing a hollow resin molded article according to the embodiment. FIG. 2 to FIG. 9 schematically illustrate manufacturing of the hollow resin molded article according to the embodiment.

The device for manufacturing a hollow resin molded article according to the embodiment for performing the method for manufacturing a hollow resin molded article according to the embodiment includes, as shown in FIG. 1, a water assist unit 1, a mold 80, and a molding machine 88 indicated by a broken line in the drawing.

The mold 80 includes a first die 81, a second die (not shown), and a sub chamber open/close valve 84. A cavity 83 is defined between the mold surface of the first die 81 and the mold surface of the second die. The first die 81 and the second die are separated from each other in the deeper side-near side direction of the drawing sheet in FIG. 1. Thus, in FIG. 1, the second die located on the near side of the drawing sheet is not shown.

The cavity 83 is composed of a main chamber 83m and a sub chamber 83s. The main chamber 83m has a mold surface for forming a hollow resin molded article, and forms a part of the cavity 83. The sub chamber 83s is contiguous to the main chamber 83m and forms another part of the cavity 83.

Of the cavity 83, the main chamber 83m is considered to be a part for forming a hollow resin molded article as described later, and the sub chamber 83s is considered to be a part for storing a melted resin material r, gas, and liquid pushed out at the time of molding the hollow resin molded article.

The sub chamber 83s has a connection path 83c to the main chamber 83m. A sub chamber open/close valve 84 is provided at the connection path 83c, and the connection path 83c is opened/closed by the sub chamber open/close valve 84.

In the mold 80, two areas 80c for forming joint portions are formed at positions where ends of the hollow resin molded article are to be molded, i.e., both ends in the longitudinal direction of the mold surface defining the main chamber 83m. In addition, two areas 80f for forming flange portions are formed between the two areas 80c. The joint portion formed by one area 80c has a come-off prevention shape having a bead portion, and the joint portion formed by the other area 80c has a come-off prevention shape in a fir-tree form. The manufacturing method and device according to the embodiment use injection molding, and therefore, modifying the shape of the mold 80 as appropriate enables a joint portion and/or a flange portion as described above to be molded integrally with the hollow resin molded article.

The mold 80 has two gates. One of the gates is a resin gate 85 for injecting the melted resin material r, and the other gate is a fluid gate 86 for injecting the gas and the liquid. A resin nozzle 89 of the molding machine 88 described later is set at the resin gate 85, and a fluid nozzle 20n of the water assist unit 1 described later is set at the fluid gate 86. The fluid nozzle 20n is integrated with the fluid gate 86 and thus is considered to form a part of the mold 80. The fluid gate 86 is located at the vertically lowermost end of the cavity 83. Therefore, the fluid nozzle 20n is considered to be connected to the vertically lowermost end of the cavity 83.

Although not shown, the mold 80 is provided with a mold drive device for mold clamping and mold opening, besides the above components. The mold drive device is connected to a control element 79 of the water assist unit 1 described later via a wire (not shown).

The molding machine 88 is an injection molding machine having the resin nozzle 89 for injecting the melted resin material r into the mold 80, and is provided with devices that a general injection molding machine has, such as a feeder and an injector (not shown). The molding machine 88 is also connected to the control element 79 of the water assist unit 1 described later via a wire (not shown).

The water assist unit 1 includes an injector 2, a liquid injection mechanism 3, a fluid flow path 53, a gas injection mechanism 6, a draining device 90, a detection element 70, and a control element 79.

The injector 2 includes a case portion 20 having a cylindrical shape, and an injector valve operation portion 25 provided inside the case portion 20. The case portion 20 is partitioned to have a gas storage chamber 21 and a valve drive chamber 22.

The gas storage chamber 21 is provided with the fluid nozzle 20n connected to the fluid gate 86 of the mold 80, an inlet 20i into which air and water flow, and an outlet 20d from which air and water are discharged.

A through hole 20p is formed in a partition wall between the gas storage chamber 21 and the valve drive chamber 22. The injector valve operation portion 25 includes a valve rod portion 26, a valve pressure receiving portion 27 provided at one end of the valve rod portion 26, and a head end valve portion 28 provided at the other end of the valve rod portion 26. The valve rod portion 26 is mounted through the through hole 20p. The valve pressure receiving portion 27 has an outer diameter substantially equal to the inner diameter of the valve drive chamber 22, and is provided in the valve drive chamber 22. The head end valve portion 28 faces the fluid nozzle 20n, inside the gas storage chamber 21.

The valve drive chamber 22 is divided into two areas by the valve pressure receiving portion 27 of the injector valve operation portion 25. One of the two areas is an injector valve retraction drive chamber 22b located on the gas storage chamber 21 side, and the other area is an injector valve advance drive chamber 22f. An injector-side first hydraulic oil flow path 47 of a hydraulic drive unit 40 described later is connected to the injector valve advance drive chamber 22f, and an injector-side second hydraulic oil flow path 48 of the hydraulic drive unit 40 described later is connected to the injector valve retraction drive chamber 22b.

The liquid injection mechanism 3 includes a liquid injection unit 30, the hydraulic drive unit 40, and a liquid supply unit 50.

The liquid injection unit 30 includes a liquid injection cylinder 31 having a cylinder shape, and a pressurizing piston 32 provided inside the liquid injection cylinder 31.

The liquid injection cylinder 31 is partitioned to have a liquid storage chamber 33 and a piston drive chamber 34. The liquid storage chamber 33 has a liquid ejection port 31d connected to a first liquid flow path 54 described later. A through hole 31p is formed in a partition wall between the liquid storage chamber 33 and the piston drive chamber 34.

The pressurizing piston 32 includes a piston rod portion 32r, a pressurizing portion 32p provided at one end of the piston rod portion 32r, and a pressure receiving portion 32pr provided at the other end of the piston rod portion 32r. The piston rod portion 32r is mounted through the through hole 31p. The pressurizing portion 32p has an outer diameter substantially equal to the inner diameter of the liquid storage chamber 33, and is provided in the liquid storage chamber 33. The pressure receiving portion 32pr has an outer diameter substantially equal to the inner diameter of the piston drive chamber 34, and is provided in the piston drive chamber 34.

The inside of the piston drive chamber 34 is divided into two areas by the pressure receiving portion 32pr of the pressurizing piston 32. One of the two areas is a pressurizing piston retraction drive chamber 34b located on the liquid storage chamber 33 side, and the other area is a pressurizing piston advance drive chamber 34f.

A liquid-side first hydraulic oil flow path 41 of the hydraulic drive unit 40 described later is connected to the pressurizing piston advance drive chamber 34f, and a liquid-side second hydraulic oil flow path 42 of the hydraulic drive unit 40 described later is connected to the pressurizing piston retraction drive chamber 34b.

In the manufacturing device according to the embodiment, the hydraulic drive unit 40 drives the pressurizing piston 32 of the liquid injection unit 30 and the above-described injector valve operation portion 25. Thus, the hydraulic drive unit 40 serves as both of a mechanism for driving the liquid injection unit 30 and a mechanism for driving the injector valve operation portion 25.

Specifically, the hydraulic drive unit 40 in the manufacturing device according to the embodiment includes a hydraulic pump mechanism P, the liquid-side first hydraulic oil flow path 41, the liquid-side second hydraulic oil flow path 42, a liquid injection hydraulic valve portion 43, a liquid-side pressure reducing valve 44, the injector-side first hydraulic oil flow path 47, the injector-side second hydraulic oil flow path 48, an injector hydraulic valve portion 49, an injector-side pressure reducing valve 45, and a hydraulic oil tank 46.

The hydraulic pump mechanism P includes a motor 40m and a valve 40v, and pressurizes and ejects hydraulic oil flowing inside. The hydraulic pump mechanism P circulates hydraulic oil through the injector-side first hydraulic oil flow path 47, the injector-side second hydraulic oil flow path 48, the liquid-side first hydraulic oil flow path 41, and the liquid-side second hydraulic oil flow path 42. The motor 40m and the valve 40v of the hydraulic pump mechanism P are connected to the control element 79 described later via wires (not shown).

More specifically, the liquid-side first hydraulic oil flow path 41 is connected to the downstream side in the transporting direction of the hydraulic pump mechanism P, and connects the pressurizing piston advance drive chamber 34f of the piston drive chamber 34 and the hydraulic pump mechanism P. The liquid-side second hydraulic oil flow path 42 is connected to the upstream side in the transporting direction of the hydraulic pump mechanism P, and connects the pressurizing piston retraction drive chamber 34b of the piston drive chamber 34 and the hydraulic pump mechanism P.

The liquid injection hydraulic valve portion 43 is connected to the liquid-side first hydraulic oil flow path 41 and the liquid-side second hydraulic oil flow path 42. The liquid injection hydraulic valve portion 43 adjusts the amount of hydraulic oil to be supplied to the liquid-side first hydraulic oil flow path 41 per unit time, and the amount of the hydraulic oil to be supplied to the liquid-side second hydraulic oil flow path 42 per unit time, independently of each other. The liquid injection hydraulic valve portion 43 is connected to the control element 79 described later via a wire (not shown).

Further, the liquid-side pressure reducing valve 44 is connected to the liquid-side first hydraulic oil flow path 41 at a position between the liquid injection hydraulic valve portion 43 and the hydraulic pump mechanism P. Further, the hydraulic oil tank 46 is connected to the liquid-side second hydraulic oil flow path 42 at a position between the liquid injection hydraulic valve portion 43 and the hydraulic pump mechanism P. The liquid-side pressure reducing valve 44 is connected to the control element 79 described later via a wire (not shown).

The injector-side first hydraulic oil flow path 47 is connected to the downstream side in the transporting direction of the hydraulic pump mechanism P, and connects the injector valve advance drive chamber 22f of the valve drive chamber 22 and the hydraulic pump mechanism P. The injector-side second hydraulic oil flow path 48 is connected to the upstream side in the transporting direction of the hydraulic pump mechanism P, and connects the injector valve retraction drive chamber 22b of the valve drive chamber 22 and the hydraulic pump mechanism P.

The injector hydraulic valve portion 49 is connected to the injector-side first hydraulic oil flow path 47 and the injector-side second hydraulic oil flow path 48. The injector hydraulic valve portion 49 adjusts the amount of hydraulic oil to be supplied to the injector-side first hydraulic oil flow path 47 per unit time, and the amount of hydraulic oil to be supplied to the injector-side second hydraulic oil flow path 48 per unit time, independently of each other. The injector hydraulic valve portion 49 is connected to the control element 79 described later via a wire (not shown).

Further, the injector-side pressure reducing valve 45 is connected to the injector-side first hydraulic oil flow path 47 at a position between the injector hydraulic valve portion 49 and the hydraulic pump mechanism P. Further, the hydraulic oil tank 46 is connected to the injector-side second hydraulic oil flow path 48 at a position between the injector hydraulic valve portion 49 and the hydraulic pump mechanism P. The injector-side pressure reducing valve 45 is connected to the control element 79 described later via a wire (not shown).

In the manufacturing device according to the embodiment, the injector valve operation portion 25 is driven by the hydraulic drive unit 40 which drives the liquid injection unit 30. However, for example, the injector valve operation portion 25 may be formed from a solenoid valve, and thus the injector valve operation portion 25 may be driven by a drive mechanism other than the hydraulic drive unit 40. In this case, the injector hydraulic valve portion is also unnecessary.

The liquid supply unit 50 includes a liquid transportation pump portion 51, a liquid feeding valve 52, the first liquid flow path 54, a liquid injection valve 56, a second liquid flow path 55, a first check valve 57, a liquid-feeding-side pressure reducing valve 58, and a liquid tank 59. In the embodiment, water is used as the liquid, and water is supplied to the liquid tank 59.

The liquid transportation pump portion 51 includes a motor 51m and a valve 51v, and pressurizes and ejects liquid flowing inside, thereby circulating the liquid through the second liquid flow path 55, the first liquid flow path 54, and the liquid storage chamber 33.

The motor 51m and the valve 51v of the liquid transportation pump portion 51 are connected to the control element 79 described later via wires (not shown).

The first liquid flow path 54 connects the liquid ejection port 31d of the liquid injection unit 30 and the fluid flow path 53 described later. The first liquid flow path 54 is connected to the gas storage chamber 21 of the injector 2 via the fluid flow path 53.

The liquid injection valve 56 is connected to the first liquid flow path 54. The second liquid flow path 55 is connected to the first liquid flow path 54 at a position upstream of the liquid injection valve 56. The second liquid flow path 55 connects the first liquid flow path 54 and the liquid tank 59. The liquid transportation pump portion 51 is connected to a part, of the second liquid flow path 55, downstream of the liquid tank 59.

The liquid-feeding-side pressure reducing valve 58 is connected at a position slightly downstream of the liquid transportation pump portion 51, in the second liquid flow path 55. The liquid feeding valve 52 is connected at a position slightly downstream of the liquid-feeding-side pressure reducing valve 58, in the second liquid flow path 55. Further, the first check valve 57 is connected at a position slightly downstream of the liquid feeding valve 52, in the second liquid flow path 55.

The liquid injection valve 56, the first check valve 57, the liquid feeding valve 52, and the liquid-feeding-side pressure reducing valve 58 are connected to the control element 79 described later via wires (not shown).

As described above, the fluid flow path 53 connects the gas storage chamber 21 of the injector 2 and the first liquid flow path 54. In addition, the fluid flow path 53 connects the gas storage chamber 21 and a gas flow path 61 described later. The fluid flow path 53 is a flow path through which liquid and gas (in the embodiment, water and air) flow.

The gas injection mechanism 6 includes a gas flow path 61, a cushion air valve 62, a second check valve 63, and a gas intake port 65. The gas intake port 65 is connected to an air pipe in a factory (not shown), a tank in which compressed air is stored (not shown), or the like.

The upstream end of the gas flow path 61 is connected to the gas intake port 65 having an opening shape. In the embodiment, air is used as the gas, and the gas intake port 65 opens to the atmosphere. As with the downstream end of the first liquid flow path 54 described above, the downstream end of the gas flow path 61 is connected to the upstream end of the fluid flow path 53.

The second check valve 63 is connected at a position slightly upstream of the downstream end connected to the fluid flow path 53, in the gas flow path 61. The cushion air valve 62 is connected at a position downstream of the gas intake port 65 and upstream of the second check valve 63, in the gas flow path 61.

The draining device 90 includes a drain path 92 and a drain valve 91. The drain path 92 connects the outlet 20d of the gas storage chamber 21 of the injector 2 and the drain valve 91. The drain valve 91 is connected to the control element 79 described later via a wire (not shown).

The detection element 70 includes an injector length-measurement sensor 71me, a liquid injection unit length-measurement sensor 72me, a liquid injection pressure sensor 72pi, a liquid injection flow rate sensor 72fr, a gas pressure sensor 73pi, a gas flow rate sensor 73fr, a hydraulic pressure sensor 74pi, a liquid tank temperature sensor 75ti, and a liquid tank level sensor 75fl.

The injector length-measurement sensor 71me is connected to the valve pressure receiving portion 27 of the injector valve operation portion 25, and detects the position of the injector valve operation portion 25 in the valve drive chamber 22.

The liquid injection unit length-measurement sensor 72me is connected to the pressure receiving portion 32pr of the pressurizing piston 32, and detects the position of the pressurizing piston 32 in the piston drive chamber 34.

The liquid injection pressure sensor 72pi is connected to the first liquid flow path 54, and detects the pressure of water ejected from the liquid injection cylinder 31 and flowing through the first liquid flow path 54.

The liquid injection flow rate sensor 72fr is connected to the first liquid flow path 54, and detects the flow rate of water ejected from the liquid injection cylinder 31 and flowing through the first liquid flow path 54.

The gas pressure sensor 73pi is connected to the gas flow path 61, and detects the pressure of air flowing through the gas flow path 61 from the gas intake port 65 toward the fluid flow path 53.

The gas flow rate sensor 73fr is connected to the gas flow path 61, and detects the flow rate of air flowing through the gas flow path 61 from the gas intake port 65 toward the fluid flow path 53.

The hydraulic pressure sensor 74pi detects the pressure of hydraulic oil ejected from the hydraulic pump mechanism P, at a position between the hydraulic pump mechanism P, and the injector-side first hydraulic oil flow path 47 and the liquid-side first hydraulic oil flow path 41.

The liquid tank temperature sensor 75ti is connected to the liquid tank 59, and detects the water temperature in the liquid tank 59.

The liquid tank level sensor 75fl is connected to the liquid tank 59, and detects the water level in the liquid tank 59.

Each sensor is connected to the control element 79 described below via a wire (not shown).

The control element 79 is a computer, is connected to each sensor described above, and receives a detection signal sent from each sensor. In the control element 79, anticipated values for detection results obtained from the respective sensors are stored in advance. The control element 79 checks a detection result obtained from each detection signal against the anticipated value, to determine appropriateness of the “states” of the gas and the liquid, i.e., pressure, flow rate, and temperature of the air and the water, on the basis of the detection value of each sensor. The detection results and the anticipated values used here may be the values of the detection results themselves, such as the magnitudes of electric signals, or may be calculated values such as water pressure calculated from the detection results.

The control element 79 is connected to the motor 40m and the valve 40v of the hydraulic pump mechanism P, the injector hydraulic valve portion 49, the injector-side pressure reducing valve 45, the liquid injection hydraulic valve portion 43, the liquid-side pressure reducing valve 44, the motor 51m and the valve 51v of the liquid transportation pump portion 51, the liquid injection valve 56, the first check valve 57, the liquid-feeding-side pressure reducing valve 58, the liquid feeding valve 52, the cushion air valve 62, the second check valve 63, and the like, and the control element 79 drives these devices.

Hereinafter, the manufacturing method according to the embodiment using the device for manufacturing a hollow resin molded article according to the embodiment will be described.

### Preparation Step

First, an operation preparation mode of the water assist unit 1 is started. On the basis of a detection result sent from each sensor, the control element 79 determines whether or not the detection result deviates from the anticipated value. Specifically, the determination is performed as follows.

(1) The control element 79 detects the air pressure in a steady state on the basis of a detection result from the gas pressure sensor 73pi and/or a detection result from the gas flow rate sensor 73fr. If the air pressure deviates from the anticipated value, the control element 79 determines that abnormality has occurred.

(2) The control element 79 detects the position of the pressure receiving portion 32pr in the piston drive chamber 34 on the basis of a detection result from the liquid injection unit length-measurement sensor 72me. More specifically, if the pressure receiving portion 32pr is not retracted to the maximum extent, the control element 79 determines that abnormality has occurred.

(3) The control element 79 detects the pressure of water flowing through the first liquid flow path 54 in a steady state on the basis of a detection result from the liquid injection pressure sensor 72pi and/or a detection result from the liquid injection flow rate sensor 72fr. If the pressure of the water deviates from the anticipated value, the control element 79 determines that abnormality has occurred.

(4) The control element 79 detects the position of the valve pressure receiving portion 27 in the valve drive chamber 22 on the basis of a detection result from the injector length-measurement sensor 71me. More specifically, if the valve pressure receiving portion 27 is not advanced to the maximum extent, the control element 79 determines that abnormality has occurred.

(5) The control element 79 detects the pressure of hydraulic oil ejected from the hydraulic pump mechanism P on the basis of a detection result from the hydraulic pressure sensor 74pi. If the pressure of the hydraulic oil deviates from the anticipated value, the control element 79 determines that abnormality has occurred.

(6) The control element 79 detects the water temperature in the liquid tank 59 on the basis of a detection result from the liquid tank temperature sensor 75ti. If the water temperature deviates from the anticipated value, the control element 79 determines that abnormality has occurred.

(7) The control element 79 detects the water level in the liquid tank 59 on the basis of a detection result from the liquid tank level sensor 75fl. If the water level deviates from the anticipated value, the control element 79 determines that abnormality has occurred.

### Resin Injection Step

If determination indicating abnormality is made on any of the above items (1) to (7), the control element 79 warns an operator about the abnormality. If determination indicating abnormality is not made on any of the above items (1) to (7), the control element 79 proceeds to the following step.

If determination indicating abnormality is not made on any of the above items (1) to (7), the control element 79 sends a signal to a drive device (not shown) for the mold 80, to clamp the mold 80 and form the cavity 83. At this time, the control element 79 closes the sub chamber open/close valve 84. Thus, as shown in FIG. 2, the main chamber 83m and the sub chamber 83s of the cavity 83 are blocked from each other by the sub chamber open/close valve 84.

Next, the control element 79 sends a signal to the molding machine 88, to perform so-called nozzle touch, i.e., pushing the resin nozzle 89 of the molding machine 88 against the resin gate 85.

After the nozzle touch, the molding machine 88 sends a pre-injection signal to the control element 79. In response to the pre-injection signal, the control element 79 sends a screw advance signal to the molding machine 88, to advance a screw (not shown) of the molding machine 88 and inject the melted resin material r in the molding machine 88 into the mold 80. At this time, the sub chamber open/close valve 84 is maintained in a closed state, and thus the main chamber 83m and the sub chamber 83s remain blocked from each other. Therefore, as shown in FIG. 3, the melted resin material r is injected into only the main chamber 83m, and is not injected into the sub chamber 83s.

After injection of the melted resin material r is completed, the control element 79 sends a signal to the drive device for the mold 80, to perform pressure holding for applying a predetermined pressure to the melted resin material r injected into the cavity 83 of the mold 80.

After the pressure holding is finished, the surface layer of the melted resin material r in the cavity 83 is cooled and thus the melted resin material r comes into a state suitable for water injection. Thereafter, the drive device for the mold 80 sends a water injection start signal to the control element 79.

### Hollow Portion Forming Step

### Cushion Air Step

In response to the water injection start signal, the control element 79 opens the cushion air valve 62 shown in FIG. 1. Thus, air in the gas flow path 61 flows to the fluid flow path 53. The air flows through the fluid flow path 53 into the gas storage chamber 21 of the injector 2. At this time, the fluid nozzle 20n of the injector 2 is in a state of being closed by the head end valve portion 28 of the injector valve operation portion 25. Therefore, the air flowing into the gas storage chamber 21 is stored in the gas storage chamber 21 without flowing into the cavity 83. That is, the gas storage chamber 21 functions as a gas storage chamber for storing the air. At this time, the pressure of the air in the gas storage chamber 21 is about 0.5 to 1.0 MPa.

In addition, at this time, since the liquid injection valve 56 is in a closed state, the air flowing through the gas flow path 61 and the fluid flow path 53 does not flow into the liquid storage chamber 33 of the liquid injection cylinder 31.

### Pressurizing Step

Next, the control element 79 drives the hydraulic pump mechanism P and opens the liquid injection hydraulic valve portion 43, to supply hydraulic oil to the pressurizing piston advance drive chamber 34f and cause hydraulic oil to be discharged from the pressurizing piston retraction drive chamber 34b. Thus, the pressure receiving portion 32pr of the pressurizing piston 32 advances due to the hydraulic pressure of the hydraulic oil. That is, at this time, the pressurizing piston 32 moves toward the liquid storage chamber 33 side of the liquid injection cylinder 31, so that the pressurizing portion 32p in the liquid storage chamber 33 advances.

Here, at the stage of the preparation step, the pressurizing piston 32 has been retracted to the maximum extent, and thus the volume of the liquid storage chamber 33 is sufficiently large. Further, at this time, the liquid storage chamber 33 is filled with water supplied from the liquid supply unit 50. Therefore, by advancing the pressurizing piston 32 so as to advance the pressurizing portion 32p, the water in the liquid storage chamber 33 is pressurized. For reference, the pressure of the water in the liquid storage chamber 33 is about 1.5 to 2.0 MPa before pressurization by the pressurizing piston 32, and about 6 to 12 MPa after the pressurization.

At the same time as advance of the pressurizing piston 32, the liquid injection valve 56 is opened, and therefore, the water inside the liquid storage chamber 33 is pushed out through the liquid ejection port 31d to the downstream side, i.e., toward the first liquid flow path 54, at high pressure. In addition, at the same time, the sub chamber open/close valve 84 of the mold 80 is opened, and the fluid nozzle 20n of the injector 2 is also opened. For opening the fluid nozzle 20n, the injector hydraulic valve portion 49 is switched to supply hydraulic oil to the injector valve retraction drive chamber 22b and cause hydraulic oil to be discharged from the injector valve advance drive chamber 22f. Thus, the valve pressure receiving portion 27 of the injector valve operation portion 25 retracts due to the hydraulic pressure of the hydraulic oil. That is, at this time, the injector valve operation portion 25 moves in a direction to separate from the gas storage chamber 21, and the head end valve portion 28 of the injector valve operation portion 25 also retracts, so that the fluid nozzle 20n of the injector 2 is opened. The air pressure in the gas storage chamber 21 is set at 0.5 to 1.0 MPa. Therefore, the melted resin material is prevented from entering the gas storage chamber 21 when the head end valve portion 28 is opened.

The water pushed out from the liquid storage chamber 33 is supplied through the first liquid flow path 54 and the fluid flow path 53 to the gas storage chamber 21 of the injector 2.

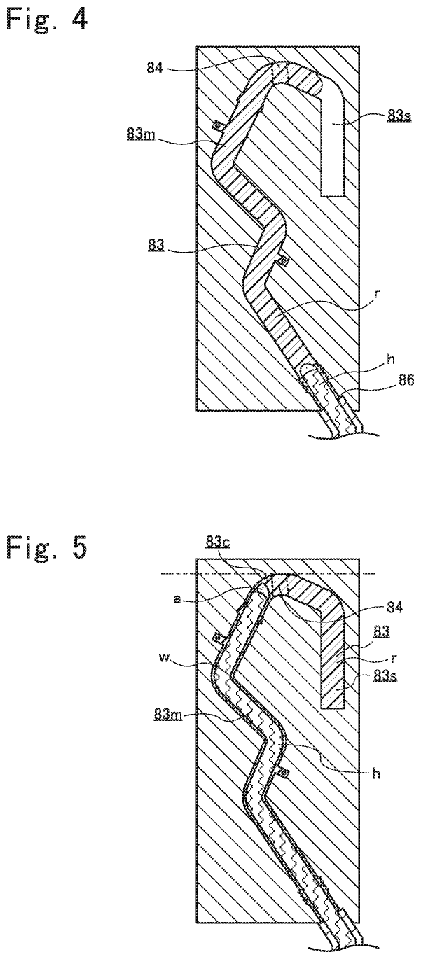

At this time, first, the air already stored in the gas storage chamber 21 is injected into the cavity 83 while being further compressed by the water pressure, and subsequently, the high-pressure water that has reached the gas storage chamber 21 is injected into the cavity 83. Thus, as shown in FIG. 4, a hollow portion h in which compressed air is contained at the leading flow end and the other part is filled with water is formed inside the melted resin material r.

At this time, the hollow portion h is formed in the main chamber 83m located on the fluid gate 86 side of the cavity 83, and extends toward the sub chamber 83s located opposite to the fluid gate 86. As described above, the sub chamber open/close valve 84 of the mold 80 at this time is opened, and thus the main chamber 83m and the sub chamber 83s of the cavity 83 communicate with each other. Therefore, the melted resin material r in the main chamber 83m is pushed out into the sub chamber 83s by an amount corresponding to the volume of the hollow portion h formed in the main chamber 83m of the cavity 83.

As injection of the water into the cavity 83 further progresses, as shown in FIG. 5, the hollow portion h further extends with the compressed air contained at the leading flow end. Then, the melted resin material r pushed out by the hollow portion h further moves from the main chamber 83m into the sub chamber 83s. The amounts of the air and the water, the volume of the sub chamber 83s, and the amount of the melted resin material r injected into the cavity 83 at this time are adjusted so that the water does not reach the sub chamber open/close valve 84. Therefore, at this time, the hollow portion h is not formed in the sub chamber 83s, and the sub chamber 83s is filled with only the melted resin material r. Thus, of the hollow resin molded article, a part formed by the sub chamber 83s is a solid body with no hollow therein.

The sub chamber open/close valve 84 is located at the vertically uppermost end in the cavity 83. Therefore, the air a in the cavity 83 stays in the connection path 83c of the sub chamber 83s, on the main chamber 83m side with respect to the sub chamber open/close valve 84. Therefore, the hollow portion h filled with the air a is formed in the melted resin material r present in the connection path 83c. Meanwhile, the hollow portion h the major part of which is filled with the water w is formed in the entirety of the melted resin material r present in the main chamber 83m. Therefore, of the hollow resin molded article, the part (as necessary, referred to as connection portion) formed by the connection path 83c of the sub chamber 83s is composed of only a hollow part, or composed of a hollow part and a solid part. Meanwhile, of the hollow resin molded article, the entire part formed by the main chamber 83m is hollow. This part is referred to as hollow formed part, as necessary.

In the pressurizing step, when the water pressure detected by the liquid injection pressure sensor 72pi shown in FIG. 1 becomes a predetermined pressure, the control element 79 stops driving of the pressurizing piston 32 by the hydraulic drive unit 40.

### Water Holding Step

After the pressurizing step, pressure holding is performed to maintain the state when driving of the pressurizing piston 32 is stopped as described above, for a predetermined period. In this state, the pressure applied to the melted resin material r from inside, i.e., from the hollow portion h, is kept constant, and the pressure from the hollow portion h is evenly applied to the entire melted resin material r present in the main chamber 83m of the cavity 83, so that the thickness of the melted resin material r in the main chamber 83m, i.e., the thickness of the hollow molded article becomes substantially uniform. At this time, the water present in the hollow portion h has lower temperature than the melted resin material r, and therefore the melted resin material r is cooled by not only the mold surface of the mold 80 but also the inside hollow portion h, so as to be solidified.

### Discharging Step

Next, the control element 79 opens the drain valve 91 while keeping the head end valve portion 28 opened.

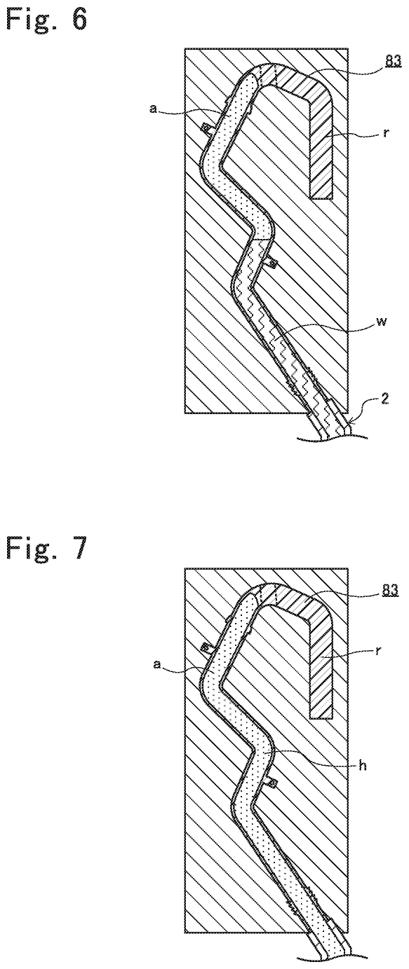

Here, the injector 2 is connected to the vertically lowermost end of the cavity 83. In addition, the head end valve portion 28 for opening/closing between the injector 2 and the cavity 83 is opened during the pressurizing step and the water holding step. In addition, during the pressurizing step and the water holding step, load in the vertical direction is applied to the water in the hollow portion h. Therefore, when the drain valve 91 is opened, as shown in FIG. 6, the water w in the hollow portion h flows down by the self-weight from the cavity 83 side to the injector 2 side. The water w flowing into the injector 2 passes through the drain valve 91 shown in FIG. 1, to be drained to the outside of the manufacturing device according to the embodiment.

The air a injected into the cavity 83 in the hollow portion forming step is in a compressed state as shown in FIG. 5 until the drain valve 91 is opened in the discharging step. Therefore, when the drain valve 91 is opened in the discharging step, the air a in the compressed state expands to press the water w as shown in FIG. 6. The air a is present at a position adjacent to the sub chamber open/close valve 84, and thus, as with the sub chamber open/close valve 84, is located at the vertically upper end in the cavity 83. Therefore, the pressing force of the air a to the water w acts downward in the vertical direction. Accordingly, the water in the hollow portion h is swiftly drained also by the pressing force of the air a.

Further, the air a in a compressed state is present at the vertically uppermost end in the hollow portion h during the pressurizing step and the water holding step, while the water w is present on the lower side and the fluid gate 86 side with respect to the air a. Therefore, the water w in the hollow portion h is pressed by the air a to the fluid gate 86 side, i.e., the drain side. Thus, the water w is inhibited from staying in the hollow portion h, so that drainage from the hollow portion h favorably progresses.

In the discharging step, at the same time as the drain valve 91 is opened, the liquid feeding valve 52 is opened to supply water for the next molding cycle, to the liquid storage chamber 33.

As shown in FIG. 7, the water w in the hollow portion h is drained in the discharging step, so that the hollow portion h is substantially filled with only the air a.

The detection element 70 shown in FIG. 1 continuously sends detection signals to the control element 79 during the hollow portion forming step. The control element 79 having received the detection signals determines, on the basis of detection results from the respective sensors, whether or not each detection result deviates from the anticipated value. Specifically, the determination is performed as follows.

(a) The control element 79 detects the pressure of air flowing through the cushion air valve 62 to the fluid flow path 53, on the basis of a detection result from the gas pressure sensor 73pi and/or a detection result from the gas flow rate sensor 73fr. If the air pressure is lower than the anticipated value, the control element 79 determines that abnormality has occurred.

(b) The control element 79 detects the position of the pressurizing piston 32 in the piston drive chamber 34 on the basis of a detection result from the liquid injection unit length-measurement sensor 72me. More specifically, if the pressure receiving portion 32pr is not advanced to the maximum extent in the pressurizing step, the control element 79 determines that abnormality has occurred.

(c) The control element 79 detects the pressure of water ejected at high pressure to the first liquid flow path 54, on the basis of a detection result from the liquid injection pressure sensor 72pi and/or a detection result from the liquid injection flow rate sensor 72fr. If the pressure of the water deviates from the anticipated value, the control element 79 determines that abnormality has occurred.

(d) The control element 79 detects the position of the valve pressure receiving portion 27 in the valve drive chamber 22 on the basis of a detection result from the injector length-measurement sensor 71me. More specifically, if the valve pressure receiving portion 27 is not retracted to the maximum extent, the control element 79 determines that abnormality has occurred.

(e) The control element 79 detects the pressure of hydraulic oil ejected from the hydraulic pump mechanism P, on the basis of a detection result from the hydraulic pressure sensor 74pi. If the pressure of the hydraulic oil deviates from the anticipated value, the control element 79 determines that abnormality has occurred.

(f) The control element 79 detects the water temperature in the liquid tank 59 on the basis of a detection result from the liquid tank temperature sensor 75ti. If the water temperature deviates from the anticipated value, the control element 79 determines that abnormality has occurred.

(g) The control element 79 detects the water level in the liquid tank 59 on the basis of a detection result from the liquid tank level sensor 75fl. If the water level deviates from the anticipated value, the control element 79 determines that abnormality has occurred.

(h) The control element 79 detects the flow rate of water ejected to the first liquid flow path 54 at high pressure, on the basis of a detection result from the liquid injection flow rate sensor 72fr. If the flow rate of the water is lower than the anticipated value, the control element 79 determines that abnormality has occurred.

If determination indicating abnormality is made on any of the above items (a) to (h), the control element 79 determines that the hollow resin molded article manufactured in this cycle is a defective product. In addition, the control element 79 warns the operator that the hollow resin molded article is a defective product.

If determination indicating abnormality is not made on any of the above items (a) to (h), the control element 79 closes the head end valve portion 28 and opens the cushion air valve 62, to perform air purge in the gas storage chamber 21 and the fluid flow path 53. As air purge gas, low-pressure air may be introduced from another circuit.

Thereafter, the control element 79 sends a mold opening signal to the mold 80. The mold 80 is driven by the mold drive device (not shown) to be opened. Thereafter, the control element 79 stands by for the next preparation step.

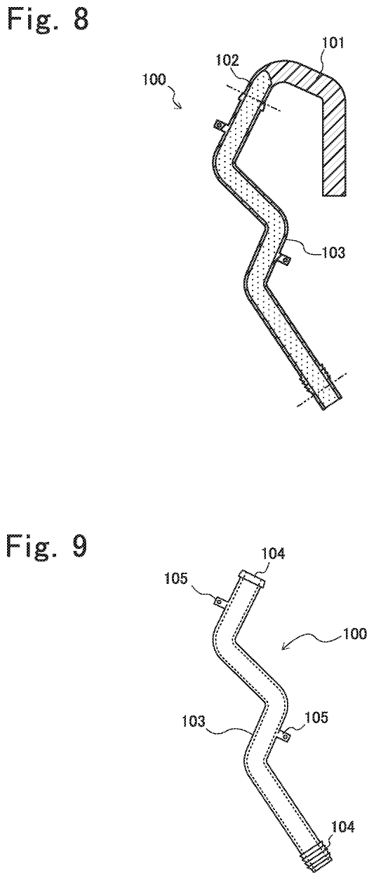

After the mold opening, the cooled and solidified hollow resin molded article 100 is taken out from the inside of the mold 80. As shown in FIG. 8, the hollow resin molded article 100 has such a shape that a solid portion 101 formed by a part of the sub chamber 83s, a connection portion 102 formed by the connection path 83c of the sub chamber 83s, and a hollow formed part 103 formed by the main chamber 83m are contiguous to each other. The hollow resin molded article 100 has a joint portion 104 and a flange portion 105.

The hollow resin molded article 100 is cut at the boundary between the connection portion 102 and the hollow formed part 103, and at the end of the hollow formed part 103 opposite to the connection portion 102, whereby a hollow resin molded article 100 formed by the hollow formed part 103 over the entirety and having the joint portion 104 and the flange portion 105 is obtained as shown in FIG. 9.

Thus, the hollow resin molded article 100 according to the embodiment is obtained through the method for manufacturing a hollow resin molded article according to the embodiment using the device for manufacturing a hollow resin molded article according to the embodiment.

In the manufacturing method according to the embodiment, drainage from the hollow portion h to outside is performed by self-weight of water. Therefore, the discharging step can be performed swiftly, and any special device is not needed for the discharging step.

In the manufacturing method according to the embodiment, the path for water to be supplied in a pressurized state to the injector 2 (i.e., liquid injection mechanism 3) and the path for air to be supplied in a compressed state to the injector 2 (i.e., gas injection mechanism 6) are separated from each other, thereby enabling individual setting for the pressure and the amount of water and the pressure and the amount of air to be injected through the injector 2 into the cavity 83. Thus, the manufacturing method according to the embodiment enables water and air to be injected into the cavity 83 at desired pressures and desired timings.

### Others

The present invention is not limited to only the embodiment described above and shown in the drawings, but may be modified as appropriate without deviating from the scope of the present invention. In addition, the components shown in the embodiment may be optionally taken out and combined with each other to carry out the present invention.

The manufacturing method and the manufacturing device according to the present invention may be expressed as follows.

[1] A method for manufacturing a hollow resin molded article, the method including:

a resin injection step of injecting a resin material r in a melted state into a cavity 83 of a mold 80;

a hollow portion forming step of injecting gas a and liquid w into the cavity 83 in which the resin material r has been injected, via an injector 2 connected to the cavity 83, to form a hollow portion h in the resin material r in the cavity 83; and

a discharging step of discharging the liquid w in the cavity 83 to outside of the cavity 83, wherein

the hollow portion forming step includes a pressurizing step of injecting the gas a in a compressed state into the injector 2 and then injecting the liquid w pressurized at higher pressure than the gas a,

the injector 2 is connected to a vertically lowermost end of the cavity 83, and

in the discharging step, the liquid w is discharged via the injector 2.

[2] The method for manufacturing the hollow resin molded article according to the above [1], wherein

a liquid injection mechanism 3 configured to supply the liquid w in a pressurized state to the injector 2 includes a liquid injection unit 30 having a liquid storage chamber 33 configured to store the liquid w and a pressurizing piston 32 configured to pressurize the liquid storage chamber 33, and a hydraulic drive unit 40 configured to drive the pressurizing piston 32, and

the gas a does not flow into the liquid storage chamber 33.

[3] The method for manufacturing the hollow resin molded article according to the above [1] or [2], wherein

the mold 80 includes a main chamber 83m which has a mold surface for forming the hollow resin molded article 100 and forms a part of the cavity 83, a sub chamber 83s which is contiguous to the main chamber 83m and forms another part of the cavity 83, and a sub chamber open/close valve 84 configured to open/close a connection path 83c of the sub chamber 83s with the main chamber 83m, and

the sub chamber open/close valve 84 is closed in the resin injection step and is opened in the pressurizing step.

[4] The method for manufacturing the hollow resin molded article according to the above [3], wherein

the sub chamber open/close valve 84 is located at a vertically uppermost end in the cavity 83.

[5] The method for manufacturing the hollow resin molded article according to any one of the above [1] to [4], wherein

in the hollow portion forming step, states of the gas a and/or the liquid w to be injected into the cavity 83 are detected,

if a detection result is determined to be abnormal, the hollow resin molded article 100 manufactured in a cycle for which the detection result is determined to be abnormal is determined to be defective, and

if a number of times of the determination indicating abnormality exceeds a predetermined value, manufacturing is stopped after a cycle is finished.

[6] A device for manufacturing a hollow resin molded article, the device including:

a mold 80 having a cavity 83;

a molding machine 88 configured to inject a resin material r in a melted state into the cavity 83; and

a water assist unit 1 configured to inject gas a and liquid w into the cavity 83 in which the resin material r has been injected, via an injector 2 connected to the cavity 83, to form a hollow portion h in the resin material r in the cavity 83, wherein

the water assist unit 1 includes
a gas injection mechanism 6 configured to supply the gas a in a compressed state to the injector 2, and
a liquid injection mechanism 3 configured to supply the liquid w in a pressurized state to the injector 2, and

the injector 2 is connected to a vertically lowermost end of the cavity 83.

[7] The device for manufacturing the hollow resin molded article according to the above [6], wherein

the liquid injection mechanism 3 includes a liquid injection unit 30 having a liquid storage chamber 33 configured to store the liquid w and a pressurizing piston 32 configured to pressurize the liquid storage chamber 33, and a hydraulic drive unit 40 configured to drive the pressurizing piston 32, and

the gas a does not flow into the liquid storage chamber 33.

[8] The device for manufacturing the hollow resin molded article according to the above [6] or [7], wherein

the mold 80 includes a main chamber 83m which has a mold surface for forming the hollow resin molded article 100 and forms a part of the cavity 83, a sub chamber 83s which is contiguous to the main chamber 83m and forms another part of the cavity 83, and a sub chamber open/close valve 84 configured to open/close a connection path 83c of the sub chamber 83s with the main chamber 83m, and

the sub chamber open/close valve 84 is closed in the resin injection step and is opened in the pressurizing step.

[9] The device for manufacturing the hollow resin molded article according to the above [8], wherein

the sub chamber open/close valve 84 is located at a vertically uppermost end in the cavity 83.

### DESCRIPTION OF THE REFERENCE CHARACTERS

1 water assist unit

2 injector

3 liquid injection mechanism

6 gas injection mechanism

30 liquid injection unit

32 pressurizing piston

33 liquid storage chamber

40 hydraulic drive unit

80 mold

83 cavity

83m main chamber

83s sub chamber

83c connection path

84 sub chamber open/close valve

88 molding machine

100 hollow resin molded article

r resin material in melted state

a gas

w liquid

h hollow portion

1. A method for manufacturing a hollow resin molded article, the method comprising:
a resin injection step of injecting a resin material in a melted state into a cavity of a mold;
a hollow portion forming step of injecting gas and liquid into the cavity in which the resin material has been injected, via an injector connected to the cavity, to form a hollow portion in the resin material in the cavity; and
a discharging step of discharging the liquid in the cavity to outside of the cavity, wherein
the hollow portion forming step includes a pressurizing step of injecting the gas in a compressed state into the injector and then injecting the liquid pressurized at higher pressure than the gas,
the injector is connected to a vertically lowermost end of the cavity, and
in the discharging step, the liquid is discharged via the injector.

2. The method for manufacturing the hollow resin molded article according to claim 1, wherein
a liquid injection mechanism configured to supply the liquid in a pressurized state to the injector includes a liquid injection unit having a liquid storage chamber configured to store the liquid and a pressurizing piston configured to pressurize the liquid storage chamber, and a hydraulic drive unit configured to drive the pressurizing piston, and
the gas does not flow into the liquid storage chamber.

3. The method for manufacturing the hollow resin molded article according to claim 1, wherein
the mold includes a main chamber which has a mold surface for forming the hollow resin molded article and forms a part of the cavity, a sub chamber which is contiguous to the main chamber and forms another part of the cavity, and a sub chamber open/close valve configured to open/close a connection path of the sub chamber with the main chamber, and
the sub chamber open/close valve is closed in the resin injection step and is opened in the pressurizing step.

4. The method for manufacturing the hollow resin molded article according to claim 3, wherein
the sub chamber open/close valve is located at a vertically uppermost end in the cavity.

5. The method for manufacturing the hollow resin molded article according to claim 1, wherein
in the hollow portion forming step, states of the gas and/or the liquid to be injected into the cavity are detected,
if a detection result is determined to be abnormal, the hollow resin molded article manufactured in a cycle for which the detection result is determined to be abnormal is determined to be defective, and
if a number of times of the determination indicating abnormality exceeds a predetermined value, manufacturing is stopped after a cycle is finished.

6. A device for manufacturing a hollow resin molded article, the device comprising:
a mold having a cavity;
a molding machine configured to inject a resin material in a melted state into the cavity; and
a water assist unit configured to inject gas and liquid into the cavity in which the resin material has been injected, via an injector connected to the cavity, to form a hollow portion in the resin material in the cavity, wherein
the water assist unit includes
a gas injection mechanism configured to supply the gas in a compressed state to the injector, and
a liquid injection mechanism configured to supply the liquid in a pressurized state to the injector, and
the injector is connected to a vertically lowermost end of the cavity.

7. The device for manufacturing the hollow resin molded article according to claim 6, wherein
the liquid injection mechanism includes a liquid injection unit having a liquid storage chamber configured to store the liquid and a pressurizing piston configured to pressurize the liquid storage chamber, and a hydraulic drive unit configured to drive the pressurizing piston, and
the gas does not flow into the liquid storage chamber.

8. The device for manufacturing the hollow resin molded article according to claim 6, wherein
the mold includes a main chamber which has a mold surface for forming the hollow resin molded article and forms a part of the cavity, a sub chamber which is contiguous to the main chamber and forms another part of the cavity, and a sub chamber open/close valve configured to open/close a connection path of the sub chamber with the main chamber.

9. The device for manufacturing the hollow resin molded article according to claim 8, wherein
the sub chamber open/close valve is located at a vertically uppermost end in the cavity.
